(19) United States
(12) Patent Application Publication
(10) Pub. No.: US 2024/0384109 A1
(43) Pub. Date: Nov. 21, 2024

(54) HYBRID POWDER COMPOSITION AND METHOD FOR PRODUCING A HYBRID POWDER COMPOSITION

(71) Applicant: AGC CHEMICALS AMERICAS, INC., Exton, PA (US)

(72) Inventors: Cedric Chin Yan Sheng, Exton, PA (US); Connie Chen Przeslawski, Downingtown, PA (US)

(21) Appl. No.: 18/667,450

(22) Filed: May 17, 2024

Related U.S. Application Data
(60) Provisional application No. 63/467,616, filed on May 19, 2023.

(51) Int. Cl. C09D 5/03; C09D 7/61; C09D 7/80; C09D 129/10; C09D 167/00

(52) U.S. Cl. CPC C09D 5/035; C09D 7/61; C09D 7/80; C09D 129/10; C09D 167/00

(57) ABSTRACT

A hybrid powder composition forms a stratified monocoat layer. The hybrid powder composition includes (A) a functionalized fluorinated polymer and (B) a non-fluorinated polymer. The functionalized fluorinated polymer (A) includes hydroxy and/or carboxylic acid functional groups and has a complex viscosity of 10 to 100 Pa-sec at 200° C. as measured in accordance with ASTM D4440-15. The non-fluorinated polymer (B) has a complex viscosity of 0.1 to 35 Pa-sec at 200° C. as measured in accordance with the same ASTM standard. A weight ratio of the functionalized fluorinated polymer (A) and the non-fluorinated polymer (B) in the hybrid powder composition is from 60/40 to 30/70. A cured monocoat layer that is stratified is formed from the hybrid powder composition.

### CROSS-REFERENCE TO RELATED APPLICATIONS

The present application claims priority to and all the benefits of U.S. Provisional Patent Application No. 63/467,616, filed on May 19, 2023, which is hereby expressly incorporated herein by reference in its entirety.

### FIELD OF THE DISCLOSURE

The subject disclosure generally relates to a hybrid powder composition for forming a stratified monocoat layer. The subject disclosure also generally relates to a cured monocoat layer formed from the hybrid powder composition, and to an extrusion method for producing a hybrid powder composition.

### BACKGROUND

Powder coating systems commonly coat various substrates to achieve aesthetic characteristics and a wide variety of functional performance characteristics including, for example, anti-corrosion properties, anti-scratch properties, impact resistance, weather resistance properties, and the like. The powder coating systems can include one or more layers and utilize fluorinated polymers in combination with other, non-fluorinated polymers to achieve the desired aesthetic and functional performance characteristics. Whether or not the powder coating system includes one layer or multiple layers, fluorinated polymers have been utilized to establish fluorine dominance in an outermost layer of the powder coating system and achieve the desired characteristics.

Conventional efforts with multiple layers for the powder coating system are cumbersome, time consuming, and costly because these efforts require discrete layers, such as an intermediate coat or layer, and a separate, topcoat layer as the outermost layer, to achieve the fluorine dominance in the outermost layer. These discrete layers are formed from compositions of differing chemistries and require multiple preparation steps and application steps (e.g. surface preparation, separate spraying, and/or separate curing steps) which are undesirable. An example of one such conventional effort is generally disclosed in FIG. 1A.

Other conventional efforts where the powder coating system is only one, or a single, layer are still cumbersome, time consuming, and costly. With only one layer, the powder compositions that are applied to form the one layer must include both the fluorinated and non-fluorinated polymers to achieve the desired characteristics. In other words, because, in this example with only a single layer, the powder coating system does not include a dedicated, fluorine-dominant topcoat layer that is separately sprayed, the powder composition that is applied to form the single layer must include both the fluorinated and non-fluorinated polymers therein. However, conventional methods for producing powder compositions having both the fluorinated and non-fluorinated polymers are not ideal. With reference to FIG. 1B, these conventional methods typically require that a powder composition with the fluorinated polymer be extruded separate from a powder composition with the non-fluorinated polymer, and then the two resulting extrudates are post-mixed, i.e., dry blended, in an additional step to establish a powder composition having both the fluorinated and non-fluorinated polymers. This approach, including the additional step of post-mixing the two extrudates together, clearly requires increased complexity, time, and cost. Furthermore, as exemplified in FIG. 1C, it is generally understood that current powder coating systems having a single layer formed from such powder compositions have too little fluorine presence at or near the top (or outermost portion) of the powder coating system, as well as inconsistent dispersion of fluorine through the entire powder coating system. In other words, the conventional powder coating systems do not have sufficient stratification after application and cure of the powder composition and, without sufficient stratification, there is insufficient fluorine dominance in the outermost layer and the desired characteristics which depend on fluorine cannot be achieved.

Thus, there remains opportunities for improved hybrid powder compositions and improved methods for producing hybrid powder compositions.

### SUMMARY OF THE DISCLOSURE

A hybrid powder composition forms a cured monocoat layer that is stratified, i.e., a stratified monocoat layer. The hybrid powder composition includes (A) a functionalized fluorinated polymer and (B) a non-fluorinated polymer. The functionalized fluorinated polymer (A) includes hydroxy and/or carboxylic acid functional groups and has a complex viscosity of 10 to 100 Pa-sec at 200° C. as measured in accordance with ASTM D4440-15. The non-fluorinated polymer (B) has a complex viscosity of 0.1 to 35 Pa-sec at 200° C. as measured in accordance with the same ASTM standard. A weight ratio of the functionalized fluorinated polymer (A) and the non-fluorinated polymer (B) in the hybrid powder composition is from 60/40 to 30/70. The cured monocoat layer that is stratified is formed from the hybrid powder composition. The functionalized fluorinated polymer (A) and the non-fluorinated polymer (B), including their respective complex viscosities and the functionality of fluorinated polymer (A), result in a hybrid powder composition that forms a powder coating system with stratification (e.g. the stratified monocoat layer) upon application of the hybrid powder composition onto a substrate and cure.

In one embodiment, an extrusion method for producing a hybrid powder composition is disclosed. In this embodiment, the hybrid powder composition incudes a fluorinated polymer and a non-fluorinated polymer. The method includes feeding the fluorinated polymer and the non-fluorinated polymer into an extruder with a screw at a feeding zone having a feed length L_{f}. The fluorinated polymer and the non-fluorinated polymer are kneaded in a kneading zone of the extruder having a kneading length Lₓ to form the hybrid powder composition. The hybrid powder composition is discharged from a discharging zone of the extruder having a discharge length L_{d}. For this extrusion method, the kneading length Lₓ of the kneading zone is from greater than 50 to 60% of an effective length Lₛ of the screw, provided a total % for the feed length L_{f} and the kneading length Lₓ and the discharge length Lₐ is 100%. In this extrusion method, the kneading length Lₓ of the kneading zone, which is from greater than 50 to 60% of the effective length Lₛ of the screw, results in a hybrid powder composition that achieves a powder coating system (e.g. a cured monocoat layer) with stratification upon application of this hybrid powder composition onto a substrate and cure.

### BRIEF DESCRIPTION OF THE DRAWINGS

Advantages of the present invention will be readily appreciated, as the same becomes better understood by reference to the following detailed description, when considered in connection with the accompanying drawings.

FIG. 1A is side view of a powder coating system of the prior art including an intermediate layer with a separate, topcoat layer as the outermost layer with fluorine.

FIG. 1B is a schematic generally illustrating a prior art method whereby a powder composition with the fluorinated polymer is extruded separate from another powder composition with the non-fluorinated polymer, and then the two resulting extrudates are mixed, i.e., dry blended, in an additional step to establish a powder composition having both the fluorinated and non-fluorinated polymers.

FIG. 1C is a digital image generated by scanning electron microscopy (SEM) with energy dispersive X-ray spectroscopy of a cross section of a single layer powder coating system of the prior art illustrating inconsistent dispersion of fluorine throughout the single layer as well as insufficient fluorine dominance in the outermost layer.

FIG. 2 is a side view of a single layer powder coating system according to this disclosure which is a cured monocoat layer that is stratified such that a top film phase of the cured monocoat layer is fluorine-dominant. FIG. 2 is schematic in nature and not to scale.

FIG. 3A is a digital image generated by scanning electron microscopy (SEM) with energy dispersive X-ray spectroscopy (EDX) of a cross section of a single layer powder coating system according to this disclosure which is a cured monocoat layer that is stratified such that a top film phase of the cured monocoat layer is fluorine-dominant, where the cured monocoat layer is formed from a hybrid powder composition including a 50/50 weight ratio of a functionalized fluorinated polymer (A) and a first non-fluorinated polymer (B), wherein the fluorinated polymer (A) is Lumiflon® LF710F and the first non-fluorinated polymer (B) is a polyester, Uralac® P 1685.

FIG. 3B is a digital image of the cured monocoat layer of the dashed/dotted rectangle of FIG. 3A with the EDX illustrating the fluorine dominance in the top film phase.

FIG. 4A is a digital image generated by SEM with EDX of a cross section of a single layer powder coating system according to this disclosure which is a cured monocoat layer that is stratified such that a top film phase of the cured monocoat layer is fluorine-dominant, where the cured monocoat layer is formed from a hybrid powder composition including titanium dioxide (TiO₂), and a 50/50 weight ratio of the functionalized fluorinated polymer (A) and a second non-fluorinated polymer (B), wherein the fluorinated polymer (A) is Lumiflon® LF710F and the second non-fluorinated polymer (B) is a polyester, SP-400.

FIG. 4B is a schematic view of the cured monocoat layer of FIG. 4A with the EDX illustrating the fluorine dominance in the top film phase, whereby the fluorine is represented by the symbol ‘+’.

FIG. 4C is a schematic view of the cured monocoat layer of FIG. 4A with the EDX illustrating titanium, from the TiO₂, concentrated in intermediate and bottom film phases such that the fluorine in the top film phase shown in FIG. 4B protects the titanium, whereby the titanium is presented by the symbol ‘°’.

FIG. 5A is a digital image generated by SEM with EDX of a cross section of a single layer powder coating system according to this disclosure which is a cured monocoat layer formed from a hybrid powder composition including the functionalized fluorinated polymer (A) and a third non-fluorinated polymer (B) (Non-Fluorinated Polymer 3, a polyester, SP-500), wherein the cured monocoat layer has an overall cured film thickness of 25 to 100microns (μm) and is stratified between a top film phase, a bottom film phase opposite the top film phase to be adjacent the substrate, and an intermediate film phase between the top and bottom film phases, and wherein the top film phase is fluorine-dominant relative to both said bottom film phase and said intermediate film phase and has a film thickness of at least 8 μm.

FIG. 5B is a digital image generated by SEM with EDX of a cross section of a single layer powder coating system according to this disclosure which is a cured monocoat layer formed from a hybrid powder composition including the functionalized fluorinated polymer (A) and a fourth non-fluorinated polymer (B) (Non-Fluorinated Polymer 4, a polyester, Desmophen® 1700, wherein the cured monocoat layer has an overall cured film thickness of 25 to 100 microns and is stratified between a top film phase, a bottom film phase opposite the top film phase to be adjacent the substrate, and an intermediate film phase between the top and bottom film phases, and wherein the top film phase is fluorine-dominant relative to both said bottom film phase and said intermediate film phase and has a film thickness of at least 8 μm.

FIG. 5C is a digital image generated by SEM with EDX of a cross section of a single layer powder coating system according to this disclosure which is a cured monocoat layer formed from a hybrid powder composition including the functionalized fluorinated polymer (A) and a fifth non-fluorinated polymer (B) (Non-Fluorinated Polymer 5, a polyester, SP-1300), wherein the cured monocoat layer has an overall cured film thickness of 25 to 100 microns and is stratified between a top film phase, a bottom film phase opposite the top film phase to be adjacent the substrate, and an intermediate film phase between the top and bottom film phases, and wherein the top film phase is fluorine-dominant relative to both said bottom film phase and said intermediate film phase and has a film thickness of at least 8 μm.

FIG. 6A is a schematic view of a screw of an extruder for use in an extrusion method according to this disclosure illustrating, in particular, a kneading zone having a kneading length Lₖ of from greater than 50 to 60% of an effective length Lₛ of the screw.

FIG. 6B is a schematic view of the screw of FIG. 6A illustrating a melting stage and a mixing stage of the kneading zone, and particular operating temperatures in the kneading zone for the extrusion method according to this disclosure.

### DETAILED DESCRIPTION OF THE DISCLOSURE

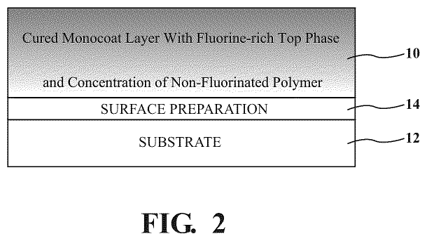

Referring generally to FIGS. 2-6, a hybrid powder composition of this disclosure ultimately forms a stratified monocoat layer. The stratified monocoat layer, also referred to throughout as a cured monocoat layer 10, is described additionally below. The hybrid powder composition is a “powder” in that the hybrid composition is generally a collection of dry particles (e.g. 96 weight % solids or higher). The dry particles can have any particle size and/or particle size distribution. For example, the dry particles of the hybrid powder composition may have an average particle size, or a particle size distribution, of 10 to 200, 50 to 200, more specifically 50 to 150, microns as determined by any technique known in the art including, but not limited to, use of a Malvern particle size analyzer, filters, and the like.

The hybrid powder composition is “hybrid” in that the powder composition includes both a fluorinated polymer and a non-fluorinated polymer. There are various embodiments of the hybrid powder composition disclosed throughout the subject description. In certain embodiments, the hybrid powder composition includes (A) a functionalized fluorinated polymer and (B) a non-fluorinated polymer. Alternatively, the hybrid powder composition may consist essentially of, or consist of, the functionalized fluorinated polymer (A) and the non-fluorinated polymer (B). In other embodiments described additionally below, the hybrid powder composition includes a fluorinated polymer which can be, but is not necessarily, functionalized. The polymers described herein can be polymers, copolymers, and terpolymers and are most commonly macromolecules. For purposes of this description, it is to be understood that the term polymer also includes low molecular weight polymers, i.e., oligomers. Additionally, for purposes of this description, non-fluorinated polymers are to be understood to be any polymer that is not a fluoropolymer, or any polymer that is free of fluorine atoms.

The functionalized fluorinated polymer (A) includes hydroxy and/or carboxylic acid functional groups. In other words, with regard to the hydroxy and/or carboxylic acid functional groups, the functionalized fluorinated polymer (A) may include only hydroxy functional groups, only carboxylic acid functional groups, or both hydroxy functional groups and carboxylic acid functional groups. The functionalized fluorinated polymer (A) can also be described to have functional groups selected from hydroxy functional groups, carboxylic acid functional group, and combinations thereof. It is to be appreciated that the functionalized fluorinated polymer (A) may also include other functional groups in addition to the hydroxy and/or carboxylic acid functional groups, such as thiol functional groups, amine functional groups, etc.

In general, the functionalized fluorinated polymer (A) is most commonly a thermoset polymer. The functionalized fluorinated polymer (A) can be any fluorinated polymer so long as the fluorinated polymer includes hydroxy and/or carboxylic acid functionality. The functionalized fluorinated polymer (A) may be selected from copolymers of chlorotrifluoroethylene (such as ethylene chlorotrifluoroethylene (ECTFE), copolymers of tetrafluoroethylene (such as ethylene tetrafluoroethylene (ETFE), polymers of tetrafluoroethylene, copolymers of fluoroethylene vinyl ether (FEVE), polymers of FEVE, copolymers of fluoroethylene vinyl ester, polymers of fluoroethylene vinyl ester, and combinations thereof. Of course, regardless of the species selected for the functionalized fluorinated polymer (A), the polymer is functionalized, i.e., includes hydroxy and/or carboxylic acid functionality.

More specifically, the functionalized fluorinated polymer (A) is preferably a hydroxy group-containing fluorinated polymer having units derived from a fluoroolefin, units derived from a monomer having a hydroxy group (hereinafter referred to also as “monomer (a1)”) copolymerizable with the fluoroolefin, and, as the case requires, units derived from another monomer (hereinafter referred to also as “monomer (a2)”) other than the fluoroolefin and the monomer (a1).

The functionalized fluorinated polymer (A) may be a hydroxy group-containing fluorinated polymer having hydroxy groups introduced by conversion of reactive groups of a polymer. A preferred hydroxy group-containing fluorinated polymer is a fluorinated polymer obtainable by reacting a fluorinated polymer having units derived from a fluoroolefin, units derived from a monomer having a reactive functional group other than a hydroxy group, and, if required, units derived from the above-mentioned monomer (a2), with a compound having a second reactive functional group reactive with said reactive functional group, and a hydroxy group.

The monomer (monomer (a1), monomer (a2), etc.) to be copolymerized with a fluoroolefin may be a monomer having fluorine atoms other than a fluoroolefin, but is preferably a monomer having no fluorine atoms.

Monomer (a1) is a monomer having a hydroxy group. The monomer having a hydroxy group may, for example, be allyl alcohol, a hydroxyethyl vinyl ether (such as 2-hydroxyethyl vinyl ether, 4-hydroxybutyl vinyl ether, cyclohexanediol monovinyl ether, etc.), a hydroxyalkyl allyl ether (such as 2-hydroxyethyl allyl ether, etc.), a vinyl hydroxy alkanoate (vinyl hydroxypropionate, etc.), or a hydroxyalkyl (meth) acrylate (such as hydroxyethyl (meth) acrylate, etc.). For monomer (a1), one type may be used alone, or two or more types may be used in combination.

Monomer (a2) may, for example, be a vinyl ether, an allyl ether, a carboxylic acid vinyl ester, a carboxylic acid allyl ester, an olefin, etc., having no reactive group. The vinyl ether may, for example, be a cycloalkyl vinyl ether (such as cyclohexyl vinyl ether (hereinafter referred to also as “CHVE”), etc.), or an alkyl vinyl ether (such as nonyl vinyl ether, 2-ethylhexyl vinyl ether, hexyl vinyl ether, ethyl vinyl ether, n-butyl vinyl ether, tert-butyl vinyl ether, etc.). The allyl ether may, for example, be an alkyl allyl ether (such as ethyl allyl ether, hexyl allyl ether, etc.). The carboxylic acid vinyl ester may, for example, be a vinyl ester of a carboxylic acid (such as acetic acid, butyric acid, pivalic acid, benzoic acid, or propionic acid). Further, as a vinyl ester of a carboxylic acid having a branched alkyl group, commercially available VeoVa-9 or VeoVa-10 (each manufactured by Shell Chemical Co., trade name) may be used. The carboxylic acid allyl ester may, for example, be an allyl ester of a carboxylic acid (such as acetic acid, butyric acid, pivalic acid, benzoic acid, or propionic acid). The olefin may, for example, be ethylene, propylene, or isobutylene. Monomer (a2) is preferably a cycloalkyl vinyl ether, particularly preferably CHVE. Monomer (a2) is preferably one having a linear or branched alkyl group having 3 or more carbon atoms. For monomer (a2), one type may be used alone, or two or more types may be used in combination.

As a combination of monomers constituting the functionalized fluorinated polymer (A) and, more specifically, the hydroxy group-containing fluorinated polymer, the following combination (1) is preferred, and the following combinations (2) or (3) are particularly preferred.

Combination (1):

Fluoroolefin: TFE or CTFE;

Monomer (a1): a hydroxy alkyl vinyl ether; and

Monomer (a2): at least one member selected from the group consisting of a

cycloalkyl vinyl ether, an alkyl vinyl ether and a carboxylic acid vinyl ester.

Combination (2):

Fluoroolefin: TFE;

Monomer (a1): a hydroxy alkyl vinyl ether; and

Monomer (a2): CHVE or a tert-butyl ether. Combination (3)

Fluoroolefin: CTFE;

Monomer (a1): a hydroxy alkyl vinyl ether; and

Monomer (a2): CHVE or a tert-butyl ether.

The proportion of fluoroolefin units is preferably from 30 to 70 mol %, particularly preferably from 40 to 60 mol %, in the total units (100 mol %) in the functionalized fluorinated polymer (A). The proportion of monomer (al) units is preferably from 0.5 to 20 mol %, particularly preferably from 1 to 15 mol %, in the total units (100 mol %) in the functionalized fluorinated polymer (A). The proportion of monomer (a2) units is preferably from 20 to 60mol %, particularly preferably from 30 to 50 mol %, in the total units (100 mol %) in the functionalized fluorinated polymer (A).

A FEVE polymer including carboxylic acid functional groups or a FEVE polymer including hydroxy functional groups are also particularly suitable for the subject hybrid powder composition. One such FEVE polymer including hydroxy functional groups is Lumiflon® LF710F commercially available from AGC Chemicals Americas, Inc. of Exton, PA. An exemplary FEVE polymer including hydroxy functionality is generally represented in Formula I below.

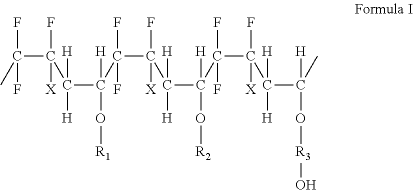

In Formula I, R₁, R₂, and R₃ are each independently selected from hydrogen or a straight or branched, substituted or unsubstituted, cyclic or non-cyclic C1 to C18 alkyl group, and each X is any halogen, preferably fluorine, provided at least one X is fluorine. Most typically, all Xs are fluorine.

The functionalized fluorinated polymer (A) has a complex viscosity of 10 to 100, typically of 20 to 80, more typically of 25 to 70, and most typically of 35 to 50, Pa-sec at 200° C. as measured in accordance with ASTM D4440-15. For measurements in accordance with ASTM D4440-15, throughout this description, the polished cone-and-plate (not parallel plates) is utilized as the apparatus/test fixture. The geometry of a respective sample is approximately 25 mm in diameter by approximately 4 mm in thickness. Alternatively, the geometry of the respective sample is 25 mm in diameter by 3 mm in thickness. Typically 1 to 5 grams, more typically 1 to 3 grams, and most typically approximately 1 gram (or actually 1 gram) of the respective sample is used to measure the complex viscosity in accordance with ASTM D4440-15. This same information described above regarding measurements in accordance with ASTM D4440-15 applies to measurements for the complex viscosity of the non-fluorinated polymer (B) described additionally below. The complex viscosity is also commonly referred to in the polymer industry as melt viscosity.

Without being limited by any particular theory, it is believed that this complex viscosity for the functionalized fluorinated polymer (A) operates in connection with the non-fluorinated polymer (B) to achieve stratification in the monocoat layer during cure of the hybrid powder composition to form the cured monocoat layer 10. This complex viscosity for the functionalized fluorinated polymer (A) of the hybrid powder composition also enables the cured monocoat layer 10 formed from the hybrid powder composition to achieve desired aesthetic characteristics and functional performance characteristics. The non-fluorinated polymer (B) and the cured monocoat layer are described additionally below.

Other relevant physical properties for the functionalized fluorinated polymer (A) of this hybrid powder composition include number average molecular weight, OH value, and glass transition temperature (T_{g}). Although the ranges for these other physical properties of the functionalized fluorinated polymer (A) as described below are not required, such ranges may further facilitate achieving the stratification in the monocoat layer described herein. The functionalized fluorinated polymer (A) may have a number average molecular weight of from 3,000 to 50,000 or, more particularly, from 5,000 to 30,000. The functionalized fluorinated polymer (A) may also have an OH value of 10 to 100, more typically of 10 to 80 or 30 to 80, and most typically of 40 to 50, mg KOH/g polymer. The functionalized fluorinated polymer (A) may further have a T_{g} of 10 to 90, more typically of 30 to 80, and most typically of 40 to 60, ° C. A particularly preferred FEVE polymer for the functionalized fluorinated polymer (A) includes hydroxy functional groups, has a complex viscosity of 35 to 50 Pa-sec at 200° C., and an OH value of from 40 to 50 mg KOH/g polymer. When a FEVE polymer including carboxylic acid functional groups is used as the functionalized fluorinated polymer (A), this carboxylated FEVE polymer may have an acid value of 1 to 60 mg KOH/g polymer.

The hybrid powder composition also includes the non-fluorinated polymer (B). As described additionally below, the non-fluorinated polymer (B) may be functionalized or non-functional, and the non-fluorinated polymer (B) may be a thermoset polymer or thermoplastic polymer. In other words, the non-fluorinated polymer (B) can be a functionalized thermoset polymer, a non-functional thermoset polymer (i.e., a thermoset polymer free of functional groups), a functionalized thermoplastic polymer, or a non-functional thermoplastic polymer (i.e., a thermoplastic polymer free of functional groups). The non-fluorinated polymer can essentially be any polymer so long as the polymer is not a fluoropolymer, i.e., is free of fluorine atoms.

Most commonly, the non-fluorinated polymer (B) is a functionalized thermoset polymer (B1). Of course, the functionalized thermoset polymer (B1) is non-fluorinated. The functional groups of the functionalized thermoset polymer (B1) are selected from hydroxy functional groups, carboxylic acid functional groups, epoxy functional groups, and combinations thereof. In other words, with regard to the functional groups of the functionalized thermoset polymer (B1), the functionalized thermoset polymer (B1) may include only hydroxy functional groups, only carboxylic acid functional groups, only epoxy functional groups, hydroxy and carboxylic acid functional groups, hydroxy and epoxy functional groups, carboxylic acid and epoxy functional groups, or all three of the hydroxy, carboxylic acid, and epoxy functional groups. The functionalized thermoset polymer (B1) can also be described to have hydroxy and/or carboxylic acid and/or epoxy functional groups. It is to be appreciated that the functionalized thermoset polymer (B1) may include other functional groups in addition to the hydroxy and/or carboxylic acid and/or epoxy functional groups, such as thiol functional groups, amine functional groups, etc.

The functionalized thermoset polymer (B1) can be any thermoset polymer so long as the polymer is not a fluoropolymer, i.e., is free of fluorine atoms, and includes functional groups selected from hydroxy functional groups, carboxylic acid functional groups, epoxy functional groups, and combinations thereof. The functionalized thermoset polymer (B1) may be selected from polyesters, polyurethanes, acrylics, epoxies, and combinations thereof. Regardless of the species selected for the functionalized thermoset polymer (B1), the thermoset polymer is functionalized, i.e., includes hydroxy and/or carboxylic acid and/or epoxy functionality. A polyester including hydroxy functional groups is particularly suitable as the functionalized thermoset polymer (B1) for the subject hybrid powder composition. Suitable polyesters including hydroxy functional groups include, but are not limited to, SP-400, SP-500, and SP-1300 which are all commercially available from Sun Polymers International, Inc. of Mooresville, IN; Uralac® P 1680 and P 1685 both commercially available from Covestro LLC of Pittsburgh, PA; and Desmophen® 1700 also commercially available from Covestro LLC of Pittsburgh, PA.

As indicated above, the non-fluorinated polymer (B) may also be a thermoplastic polymer, which can be functionalized or not. When the non-fluorinated polymer (B) is a thermoplastic polymer it is most commonly a thermoplastic polymer that is free of functional groups (B2). Exemplary thermoplastic polymers that are free of functional groups (B2) include, but are not limited to, thermoplastic polymers selected from polyvinyl chloride, polyalkylenes, polyalkylene terephthalates, polyvinyl butyrate, polyamide, and combinations thereof. Polyvinyl butyrate is particularly suitable for the non-fluorinated polymer (B) when a thermoplastic polymer that is free of functional groups (B2) is desired.

Regardless of whether the non-fluorinated polymer (B) is functionalized or not, and regardless of whether the non-fluorinated polymer (B) is a thermoset polymer or a thermoplastic polymer, the non-fluorinated polymer (B) has a complex viscosity of 0.1 to 35, more typically of 0.3 to 20, and most typically of 0.5 to 10, Pa-sec at 200° C. as measured in accordance with ASTM D4440-15. Without being limited by any particular theory, it is believed that this complex viscosity of the non-fluorinated polymer (B) operates in connection with the functionalized fluorinated polymer (A) to achieve stratification in the monocoat layer during cure of the hybrid powder composition to form the cured monocoat layer 10. This complex viscosity for the non-fluorinated polymer (B) of the hybrid powder composition also enables the cured monocoat layer 10 formed from the hybrid powder composition to achieve desired aesthetic characteristics and functional performance characteristics. The cured monocoat layer 10 is described additionally below.

Other relevant physical properties for the non-fluorinated polymer (B) of this hybrid powder composition include OH value and glass transition temperature (T_{g}). Although the ranges for these other physical properties of the non-fluorinated polymer (B) as described below are not required, such ranges may further facilitate achieving the stratification in the monocoat layer described herein. The non-fluorinated polymer (B) may have an OH value of 5 to 200, more typically of 10 to 180, and most typically of 20 to 140, mg KOH/g polymer. The non-fluorinated polymer (B) may also have a T_{g} of 30 to 90, more typically of 40 to 80, and most typically of 50 to 70, ° C. A particularly preferred polyester for the non-fluorinated polymer (B) is thermoset, includes hydroxy functional groups, has a complex viscosity of 0.5 to 10 Pa-sec at 200° C., and an OH value of 20 to 140 mg KOH/g polymer.

The weight ratio of the functionalized fluorinated polymer (A) and the non-fluorinated polymer (B) is from 60/40 to 30/70, more typically from 60/40 to 35/65 or from 60/40 to 40/60 or from 60/40 to 45/55, and most typically from 55/45 to 45/55. At this weight ratio for the functionalized fluorinated polymer (A) and the non-fluorinated polymer (B), the hybrid powder composition forms the cured monocoat layer 10 with desired aesthetic characteristics and functional performance characteristics. This weight ratio of the functionalized fluorinated polymer (A) and the non-fluorinated polymer (B) of 60/40 to 30/70, including the more specific weight ratios between 60/40 to 30/70, drives the stratification in the cured monocoat layer 10 and achieve desired aesthetic characteristics and functional performance characteristics. This particular weight ratio of the functionalized fluorinated polymer (A) and the non-fluorinated polymer (B) of 60/40 to 30/70 renders the hybrid powder composition ‘self-stratifying’ thereby driving the stratification in the cured monocoat layer 10. In fact, with weight ratios of the functionalized fluorinated polymer (A) and the non-fluorinated polymer (B) outside the range of 60/40 to 30/70, the hybrid powder composition is not ‘self-stratifying’. As such, cured monocoat layers formed from such hybrid powder compositions are not stratified, as exemplified in greater detail below in the Examples.

The functionalized fluorinated polymer (A) may be present in the hybrid powder composition in an amount of from 15 to 60, more typically 20 to 50, and most typically 25 to 40, parts by weight based on a total weight of the hybrid powder composition. Similarly, the non-fluorinated polymer (B) may be present in the hybrid powder composition in an amount of from 15 to 60, more typically 20 to 50, and most typically 25 to 40, parts by weight based on a total weight of the hybrid powder composition.

As described above, the functionalized fluorinated polymer (A) has a complex viscosity of 10 to 100, typically of 20 to 80, more typically of 25 to 70, and most typically of 35 to 50, Pa-sec at 200° C. as measured in accordance with ASTM D4440-15, and the non-fluorinated polymer (B) has a complex viscosity of 0.1 to 35, more typically of 0.3 to 20, and most typically of 0.5 to 10, Pa-sec at 200° C. Additionally, although not required, it is beneficial if a difference between the complex viscosity of the functionalized fluorinated polymer (A) and the complex viscosity of the non-fluorinated polymer (B) is at least 20, more typically at least 25, Pa-sec at 200° C. Alternatively, this difference between the complex viscosities of the functionalized fluorinated polymer (A) and the non-fluorinated polymer (B) is from 20 to 80, more typically from 20 to 60, Pa-sec at 200° C. To further elaborate on embodiments where the difference between the complex viscosity of the functionalized fluorinated polymer (A) and the complex viscosity of the non-fluorinated polymer (B) is at least 20 Pa-sec at 200° C., in these embodiments, the minimum value for the complex viscosity of the functionalized fluorinated polymer (A) necessarily has to be 20.1 Pa-sec or greater at 200° C. because the minimum possible value for the complex viscosity of the non-fluorinated polymer (B) is 0.1 Pa-sec at 200° C. In other words, in these particular embodiments, the broad range for the complex viscosity of the functionalized fluorinated polymer (A) of 10 to 100 Pa-sec at 200° C. and the broad range for the complex viscosity of the non-fluorinated polymer (B) of 0.1 to 35 Pa-sec at 200° C. remain applicable to the extent, or provided, that the difference between the complex viscosity of the functionalized fluorinated polymer (A) and the complex viscosity of the non-fluorinated polymer (B) remains at least 20 Pa-sec at 200° C.

Like the weight ratio of the functionalized fluorinated polymer (A) and the non-fluorinated polymer (B) of 60/40 to 30/70, the difference between the complex viscosities of the functionalized fluorinated polymer (A) and the non-fluorinated polymer (B) drives the stratification in the cured monocoat layer 10 and achieves desired aesthetic characteristics and functional performance characteristics. This difference between the complex viscosities therefore also renders the hybrid powder composition ‘self-stratifying’ thereby driving the stratification in the cured monocoat layer 10.

In one preferred embodiment for the hybrid powder composition, the functionalized fluorinated polymer (A) has an OH value of 10 to 100 mg KOH/g polymer, and the non-fluorinated polymer (B) has an OH value of 5 to 200 mg KOH/g polymer. In another preferred embodiment for the hybrid powder composition, the functionalized fluorinated polymer (A) has a glass transition temperature, T_{g}, of 10 to 90° C., and the non-fluorinated polymer (B) has a glass transition temperature, T_{g}, of 30 to 90° C. In a further preferred embodiment for the hybrid powder composition, the functionalized fluorinated polymer (A) has a complex viscosity of 25 to 70 Pa-sec at 200° C. and an OH value of 30 to 80 mg KOH/g polymer, and the non-fluorinated polymer (B) has a complex viscosity of 0.3 to 20 Pa-sec at 200° C. and an OH value of 10 to 180 mg KOH/g polymer. Although not required, in the select embodiments in this paragraph, it is further advantageous if the weight ratio of the functionalized fluorinated polymer (A) and the non-fluorinated polymer (B) is from 55/45 to 45/55, more typically 50/50.

Although not required, the hybrid powder composition may also include titanium dioxide (TiO₂). The titanium dioxide is not particularly limited and may be any known in the art. For example, the titanium dioxide may be of any particle size and have an average particle size with any distribution known in the art. If present, the titanium dioxide may also be surface treated with one or more treatments of one or more metal oxides, e.g. aluminum oxide, silicon oxide, etc. In various embodiments, the titanium dioxide is present in the hybrid powder composition in an amount of from 1 to 40, 2 to 20, 5 to 15, percent by weight based on a total weight of the hybrid powder composition. The amount of the titanium dioxide utilized in the hybrid powder composition can influence, among other aesthetic and functional performance characteristics, color and gloss retention over time due to weathering, as well as impact and corrosion resistance in cured monocoat layer 10.

With regard to impact resistance, it is known that conventional powder coating systems formed from conventional powder compositions with titanium dioxide commonly fail impact testing due to cracking in the powder coating system. In contrast, when the hybrid powder composition of this disclosure includes titanium dioxide, the cured monocoat layer 10 formed from this hybrid powder composition with titanium dioxide typically passes at least one of direct impact testing and reverse (or indirect) impact testing as measured at 30 cm in accordance with ASTM D2794-93, i.e., there is no cracking in the cured monocoat layer 10 upon testing. In other words, the cured monocoat layer 10 of this disclosure may only pass the direct impact testing, may only pass the reverse impact testing, or may pass both the direct and reverse impact testing. For direct impact testing, the test panel includes the cured monocoat layer 10 on top, or facing upwards toward the indenter, so the indenter directly strikes the cured monocoat layer 10 thereby causing a convex test area in the cured monocoat layer 10 for evaluation. For reverse, or indirect, impact testing, the test panel is ‘flipped’ so that the cured monocoat layer 10 is on bottom, or facing downwards away from the indenter, so the indenter strikes the test panel opposite the cured monocoat layer 10, i.e., the indenter never directly strikes the cured monocoat layer 10. Here, when the indenter strikes the test panel opposite the cured monocoat layer 10, a concave test area is formed in the cured monocoat layer 10 for evaluation. For this ASTM, the indenter used was a steel punch with a hemispherical head having a diameter of 0.500 in. (or 12.7 mm).

Examples of titanium dioxides that can be used in the hybrid powder composition include, but are not limited to: Ti-Pure™ R-101; Ti-Pure™ R-103; Ti-Pure™ R-104; Ti-Pure™ R-105; Ti-Pure™ R-350; TS-6200; Ti-Pure™ Select TS-6300; Ti-Pure™ R-706; Ti-Pure™ R-741; Ti-Pure™ R-746; Ti-Pure™ R-796+; Ti-Pure™ R-900; Ti-Pure™ R-902+; Ti-Pure™ R-931; Ti-Pure™ R-942P; Ti-Pure™ R-960 for Plastics; Ti-Pure™ R-960 for Coatings; Ti-Pure™ TS-6200; Biasill™; Staurolite Sand; Starblast™; Starblast™ Ultra; Staurolite; Zircon Sands; Zircore™; Kyasill™; and combinations thereof. Exemplary titanium dioxide is commonly described in the art as a “super durable” titanium dioxide and is commercially available from The Chemours Company of Wilmington, DE. Regardless of the particular titanium dioxide selected for inclusion in the hybrid powder composition, any surface treatment on the titanium dioxide may contribute to the further resistance of aesthetic and/or functional performance failures due to weathering.

In the broadest sense, the hybrid powder composition does not have to include a curing agent, i.e., the hybrid powder composition can be free of a curing agent. However, the hybrid powder composition typically does include a curing agent that is reactive with at least one of the functionalized fluorinated polymer (A) and the non-fluorinated polymer (B). In other words, the curing agent is reactive with only the functionalized fluorinated polymer (A), with only the non-fluorinated polymer (B), or with both the functionalized fluorinated polymer (A) and the non-fluorinated polymer (B), even if to varying degrees of reactivity with each. The curing agent reacts with the functionalized fluorinated polymer (A) and/or with the non-fluorinated polymer (B) to cross-link. More specifically, if present, the curing agent chemically reacts with the hydroxy and/or carboxylic acid functional groups of the functionalized fluorinated polymer (A) and/or with the functional groups of the non-fluorinated polymer (B), when the non-fluorinated polymer (B) is functionalized, and crosslinks with the functionalized fluorinated polymer (A) and/or with the non-fluorinated polymer (B). As is known in the art, curing agents in the context of powder compositions are also commonly referred to as crosslinkers or as crosslinking agents.

The curing agent can be any curing agent suitable for chemical reaction with the functional groups of the functionalized fluorinated polymer (A) and/or with the functional groups of the non-fluorinated polymer (B), when the non-fluorinated polymer (B) is functionalized. Most typically, the curing agent is selected from a blocked isocyanate, triglycidyl isocyanurate, hydroxyalkyl amide, and combinations thereof. With regard to an isocyanate as a suitable curing agent, both unblocked and blocked isocyanates are possible for inclusion in the hybrid powder composition; however, it is to be understood that blocked isocyanates are preferred relative to unblocked isocyanates. One suitable curing agent, a blocked isocyanate, is VESTAGON® B 1530 commercially available from Evonik Industries AG of Essen, Germany. As one example, where the hybrid powder composition includes a FEVE polymer including hydroxy functional groups as the functionalized fluorinated polymer (A), a polyester including hydroxy functional groups as the non-fluorinated polymer (B), and a blocked isocyanate as the curing agent, upon cure of the hybrid powder composition and the resultant de-blocking of the blocked isocyanate, the isocyanate reacts with the hydroxy functional groups of the functionalized fluorinated polymer (A) and of the non-fluorinated polymer (B) to establish the cured monocoat layer 10 that is thermoset including urethane bonding or linkages.

The hybrid powder composition can include other components, e.g. additives, in addition to the functionalized fluorinated polymer (A), the non-fluorinated polymer (B), the titanium dioxide (when present), and the curing agent (when present). Exemplary additives include, but are not limited to, flow additives, matting agents, degassing agents, extender pigments, primary pigments other than titanium dioxide, surfactants, ultra-violet (UV) absorbers, hindered amine light stabilizers (HALS), anti-static agents, and the like.

Referring, in particular, to FIG. 2, the cured monocoat layer 10 is formed from a hybrid powder composition and is disposed on a substrate 12. The cured monocoat layer 10 of this disclosure may also be referred to as a powder coating system 10 and can be disposed on any substrate 12. The cured monocoat layer 10 of this description may be formed from any hybrid powder composition. Notably, the hybrid powder composition that forms the cured monocoat layer 10 of this description can be the same as or different from the hybrid powder composition described above.

Common substrates that the hybrid powder composition is applied to for forming the cured monocoat layer 10 include, but are not limited to, wood substrates, carbon fiber substrates, polyvinyl chloride (PVC) substrates, aluminum substrates, and fiberglass substrates. An aluminum substrate 12 is a particularly preferred substrate 12 for the hybrid powder composition. Although not required, the substrate 12 may have its outermost surface prepared prior to application of the hybrid powder composition to form the cured monocoat layer 10 on the substrate 12. During surface preparation, considerations such as degreasing and etching of the substrate 12 are commonly addressed. Chromate surface preparation is most typical for the substrate 12 and the hybrid powder composition of this description. As best represented in FIG. 2, the surface preparation method or technique establishes a surface preparation layer 14 between the substrate 12 and the applied hybrid powder composition (and, ultimately, between the substrate 12 and the cured monocoat layer 10). This surface preparation layer 14 can vary in composition and thickness to influence certain physical properties including, but not limited to, overall corrosion protection and adhesion.

The hybrid powder composition can be disposed on the substrate 12 by a wide variety of powder application techniques including, but not limited to, dipping or immersing the substrate 12 into the hybrid powder composition, or electrostatically spraying the hybrid powder composition onto the substrate 12. Once the hybrid powder composition has been applied to the substrate 12, the substrate 12 with the hybrid powder composition is cured to form the cured monocoat layer 10. Curing the hybrid powder composition requires a curing temperature and a curing time to heat and melt the hybrid powder composition and to maintain a molten state for a predetermined period of time. The curing temperature and the curing time are typically established depending on a variety of factors including, for example, the type and amount of the components in the hybrid powder composition, the desired cured film thickness, etc. The curing temperature and the curing time are further established depending on the reaction temperature of the particular curing agent. For instance, when the curing agent is a blocked isocyanate, the curing temperature is typically from 170 to 210° C. (at a temperature whether the blocked isocyanate de-blocks), and the curing timing is typically from 5 to 120minutes, more typically from 10 to 60 minutes. Upon cure, the monocoat layer has an overall cured film thickness of from 25 to 100, more typically from 30 to 80, and most typically from 50 to 60, microns.

Referring to FIGS. 2-5, the cured monocoat layer 10 is stratified between a top film phase 16, a bottom film phase 18 opposite the top film phase 16 to be adjacent the substrate 12, and an intermediate film phase 20 between the top and bottom film phases 16, 18. The top film phase 16 of the cured monocoat layer 10 is adjacent the top or outermost (environmentally facing) surface 17 of the cured monocoat layer 10. Because the cured layer 10 is a monocoat, i.e., only one or a single layer, an outermost portion or outermost layer of the cured monocoat layer 10 is not a discrete layer itself. Instead, the outermost portion or layer is the top film phase 16 and there is no discrete boundary between this top film phase 16 and the intermediate film phase 20 which is adjacent the top film phase 16. Any boundaries within the cured monocoat layer 10 are indistinct. For example, the boundary between the intermediate film phase 20 and the bottom file phase 18 is also indistinct.

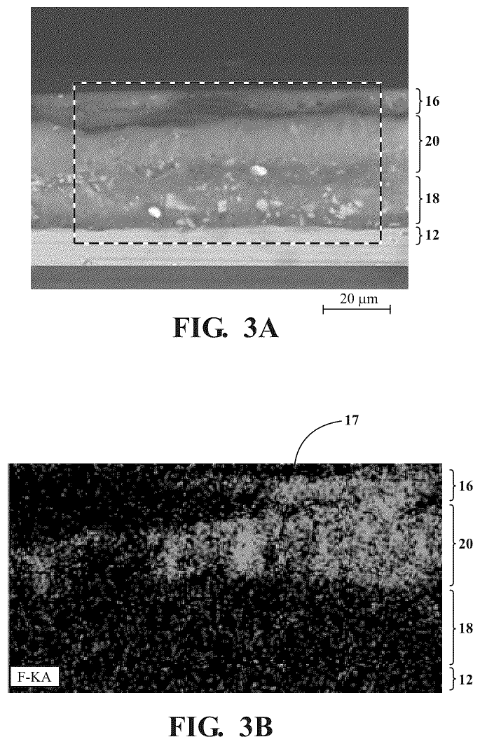

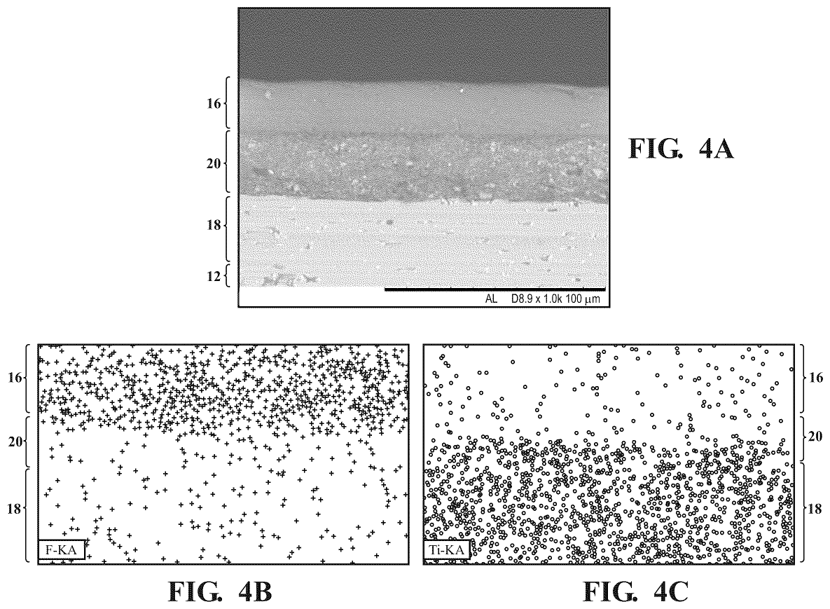

The stratification between the top, bottom, and intermediate film phases 16, 18, 20 is also considered a gradient or phase separation within the cured monocoat layer 10. This gradient is specifically represented by the gradient, or differing degrees of gray-scale, shading in FIG. 2. Referring now generally to FIGS. 3-5, with this stratification, the top film phase 16 is fluorine-dominant (i.e., fluorine rich) relative to both the bottom film phase 18 and the intermediate film phase 20. The fluorine dominance in the top film phase 16 means that the top film phase 16 has more fluorine in comparison to the bottom and intermediate film phases 18, 20. The fluorine dominance in the top film phase 16 is generally consistent across the cured monocoat layer 10, i.e., the fluorine dominance is not sporadic. Notably, as best represented by the fluorine presence in FIGS. 3B and 4B, the fluorine can be dispersed throughout the entirety of the cured monocoat layer 10, with some amounts of fluorine still existing in the intermediate and bottom film phases 20, 18, and the top film phase 16 is still fluorine-dominant so long as there is a greater concentration of fluorine in the top film phase 16 in comparison to the concentration of fluorine in the intermediate and bottom film phases 20, 18. The fluorine dominance in the top film phase 16 forms the cured monocoat layer 10 with the desired functional performance characteristic of weather resistance. Notably, with respect to FIGS. 3A and 3B, it is to be appreciated that these digital SEM images are not necessarily to scale relative to one another. As such, comparison of the thickness of the various film phases 16, 20, 18 as they are represented in FIG. 3A cannot be made relative to the thickness of the various film phases 16, 20, 18 as they are represented in FIG. 3B.

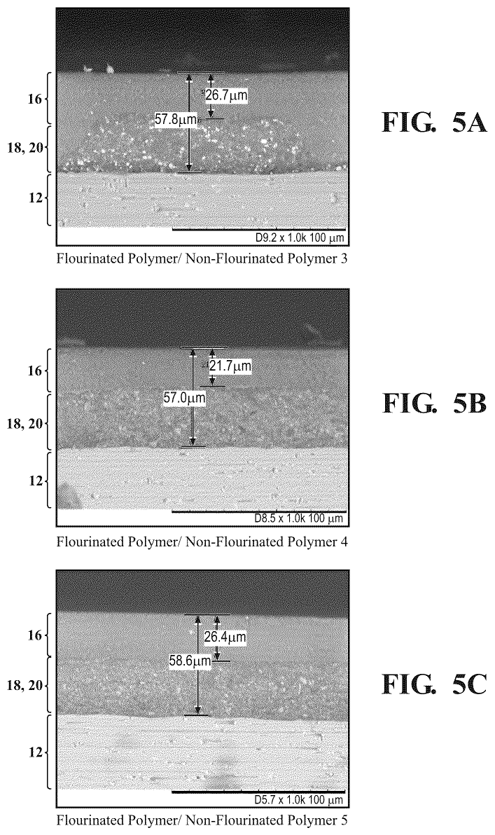

Referring generally to FIGS. 5A-5C, the cured monocoat layer 10 is formed from the functionalized fluorinated polymer (A) and three, different non-fluorinated polymers (B).

The cured monocoat layer 10 has an overall film thickness of 25 to 100 microns, specifically 57.8 microns for the cured monocoat layer 10 of FIG. 5A, 57.0 microns for the cured monocoat layer 10 of FIG. 5B, and 58.6 microns for the cured monocoat layer 10 of FIG. 5C. Furthermore, as these particular Figures illustrate, the top film phase 16, where the cured monocoat layer 10 is fluorine dominant, can vary in film thickness. The top film phase 16 preferably has a film thickness with fluorine dominance of at least 8 microns. Alternatively, the film thickness of the top film phase can be at least 10 microns or range from 8 to 50, from 10 to 50, from 10 to 35, from 15 to 35, from 15 to 30, and from 17 to 30, microns. As specifically shown in FIGS. 5A-5C, the film thickness of the top film phase 16 is 26.7 microns in FIG. 5A, the film thickness of the top film phase 16 is 21.7 microns in FIG. 5B, and the film thickness of the top film phase 16 is 26.4 microns in FIG. 5C. The thickness of the top film phase 16 can also be understood as a percentage of the overall cured film thickness of the cured monocoat layer 10. In this context, non-limiting examples for the thickness of the top film phase 16 include examples where the thickness of the top film phase 16 is 25 to 55%, optionally 35 to 55%, and further optionally 40 to 50%, of the overall cured film thickness of the cured monocoat layer 10.

Although not required for all embodiments, the intermediate film phase 20 may be fluorine-dominant relative to the bottom film phase 18, i.e., the intermediate film phase 20 may have more fluorine in comparison to the bottom film phase 18. In this situation where the intermediate film phase 20 is fluorine-dominant relative to the bottom film phase 18, the cured monocoat layer 10 includes a gradient where a concentration of fluorine in the cured monocoat layer 10 consistently decreases from the top film phase 16 down through the intermediate film phase 20 and to the bottom film phase 18.

Referring generally to FIGS. 4A-4C, the hybrid powder composition of this disclosure is particularly suitable for protecting cured monocoat layers 10 having titanium dioxide from aesthetic and/or functional performance failures due to weathering, e.g. exposure to ultraviolet (UV) radiation from the sun, exposure to UVA lamps as commonly used in QUV accelerated weathering testing, and exposure to moisture from the elements. More specifically, it is generally understood that titanium dioxide is susceptible to degradation due to a photocatalytic reaction that can be promoted by the UV radiation and moisture. The fluorine dominance in the top film phase 16 of the cured monocoat layer 10 resists aesthetic and/or functional performance failures due to weathering. More specifically, the bond strength, i.e., the bond disassociation energy, of the fluorine-carbon (F—C) bond can exceed 500 kJ/mol and this amount is capable of resisting energy in the UV region from sunlight (primarily UV-A) which commonly ranges from 315 to 400 kJ/mol. Due to the fluorine dominance in the top film phase 16 of the cured monocoat layer 10, there is a prevalence of the F—C bonds in the top film phase 16 (which is closest to the sun) and these F—C bonds are strong in comparison to other chemical bonds, such as the C—C bond.

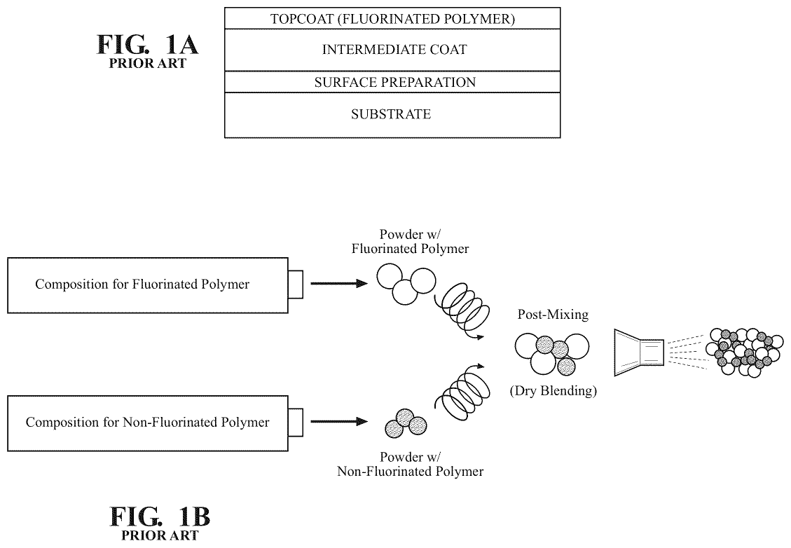

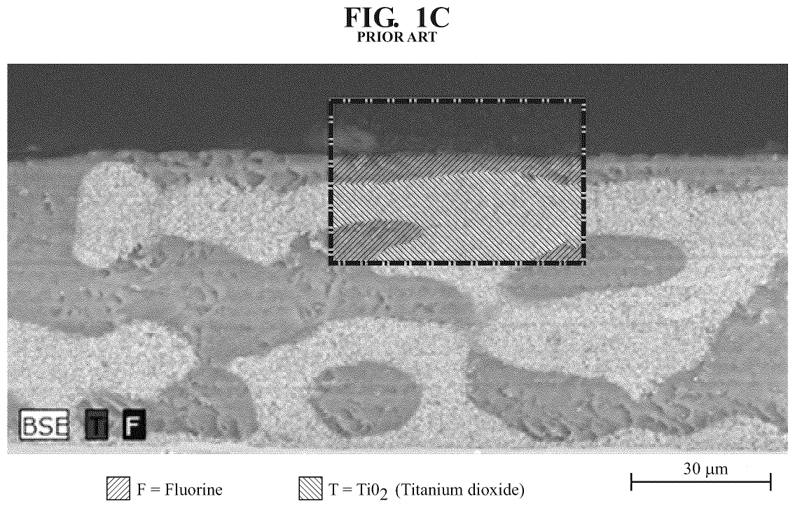

As a result, it is to be appreciated that the cured monocoat layers 10 of this disclosure exhibit improved weathering in comparison to cured monocoat layers of the prior art that do not have fluorine dominance in their respective top or outermost (environmentally facing) surface. As one example, such cured monocoat layers of the prior art that do not have fluorine dominance in their respective top or outermost surface are commonly formed from powder compositions including only polyester and no functionalized fluorinated polymer (A). It is also to be appreciated that the cured monocoat layers 10 of this disclosure exhibit at least the same, and possibly even improved, weathering in comparison to conventional efforts which rely on multiple discrete layers for their powder coating system such as those conventional efforts represented in prior art FIG. 1A. For purposes of this disclosure, the terminology improved weathering refers to gloss performance (e.g. gloss retention) over time.

With specific reference to the cured monocoat layer 10 of FIGS. 4A-4C, the hybrid powder composition which forms the cured monocoat layer 10 includes the functionalized fluorinated polymer (A), a non-fluorinated polymer (B), and titanium dioxide (TiO₂). In the schematic view of FIG. 4B, SEM/EDX imaging illustrates the fluorine dominance in the top film phase 16, whereby the fluorine is represented by the symbol ‘+’. As is clearly shown, there is a predominance, or higher concentration, of + (fluorine) in the top film phase 16. Furthermore, using the symbol ‘o’, the schematic view of FIG. 4C illustrates titanium, from the TiO₂, concentrated not in the top film phase 16, but in the intermediate film phase 20 and in the bottom film phase 18 such that the fluorine in the top film phase 16 (shown in FIG. 4B) protects the titanium from the aesthetic and/or functional performance failures referenced above. Notably, the titanium is primarily present in the intermediate and bottom film phases 20, 18 together with a majority amount of the non-fluorinated polymer (B), such as a polyester comprising hydroxy functional groups. In other words, due to stratification, the non-fluorinated polymer (B) is primarily in the intermediate and bottom film phases 20, 18, whereas the fluorinated polymer (A), such as FEVE polymer comprising hydroxy functional groups, is primarily in the top film phase 16. It is to be appreciated that the schematic views of FIGS. 4B and 4C are not to scale relative to the scale in the digital SEM image of FIG. 4A. As such, comparison of the thickness of the various film phases 16, 20, 18 as they are represented in FIGS. 4B and 4C cannot be made relative to the thickness of the various film phases 16, 20, 18 as they are represented in FIG. 4A.

As indicated above, the cured monocoat layer 10 of this description may be formed from any hybrid powder composition. More specifically, the cured monocoat layer 10 of this description may be formed from any hybrid powder composition, provided the cured monocoat layer 10 that is formed has an overall cured film thickness of 25 to 100 microns and has the fluorine dominance relative to both the bottom film phase 18 and the intermediate film phase 20 as described above. Although not required, the cured monocoat layer 10 of this description is most commonly formed from the hybrid powder composition described above, specifically where the hybrid powder composition includes the functionalized fluorinated polymer (A) which includes hydroxy and/or carboxylic acid functional groups and has a complex viscosity of 10 to 100 Pa-sec at 200° C. as measured in accordance with ASTM D4440-15, and the non-fluorinated polymer (B) having a complex viscosity of 0.1 to 35 Pa-sec at 200° C. as measured in accordance with the same ASTM standard, both at the weight ratio of from 70/30 to 30/70 .

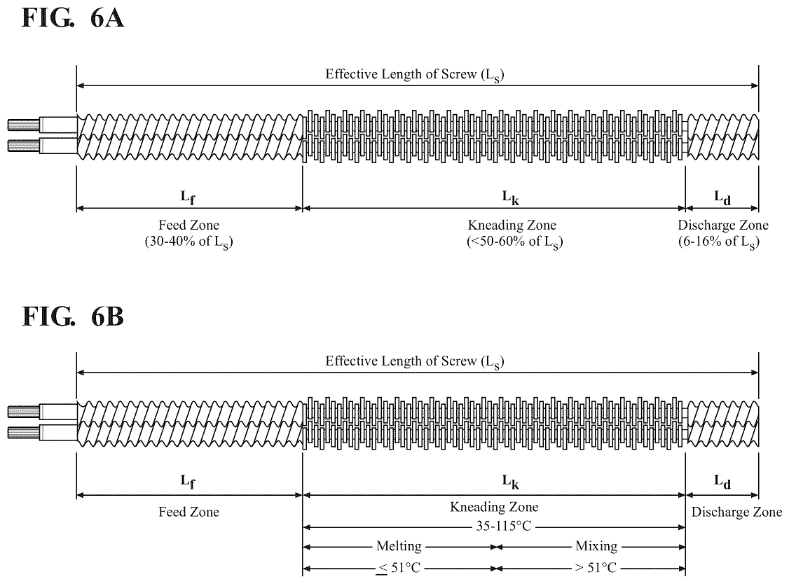

Referring generally to FIGS. 6A and 6B, an extrusion method produces a hybrid powder composition. The hybrid powder composition produced according to the subject extrusion method can be the same as or different from the hybrid powder composition described above. A primary distinction is that the extrusion method in this disclosure does not require either the fluorinated polymer or the non-fluorinated polymer that are used to necessarily be functionalized. The fluorinated polymer and the non-fluorinated polymer that are used in this extrusion method can be functionalized, but they do not necessarily have to be.

Referring to FIG. 6A, the extrusion method includes feeding the fluorinated polymer and the non-fluorinated polymer into an extruder with a screw at a feeding zone having a feed length L_{f}, kneading the fluorinated polymer and the non-fluorinated polymer in a kneading zone of the extruder having a kneading length Lₖ to form the hybrid powder composition, and discharging the hybrid powder composition from a discharging zone of the extruder having a discharge length L_{d}.

With regard to the feeding of the fluorinated polymer and the non-fluorinated polymer into the extruder, the fluorinated polymer and the non-fluorinated polymer, along with any other components, e.g. additives, can be fed into the extruder separately or together. When the fluorinated polymer, the non-fluorinated polymer, and any other components are fed separately into the extruder, then these components are first mixed in the extruder. On the other hand, in more preferred embodiments for the extrusion method of this disclosure, the fluorinated polymer, the non-fluorinated polymer, and any other components are already mixed together (pre-mixed) to some extent before being fed into the extruder. When the fluorinated polymer, the non-fluorinated polymer, and any other components are fed together into the extruder, all of the components are typically pre-mixed outside, or independent, of the extruder thereby first forming a pre-mix composition, and this pre-mix composition is then fed into the extruder, typically via a feed hopper.

The extruder has an overall volume capacity at the feeding zone and, although not required, during the feeding of the fluorinated polymer and the non-fluorinated polymer into the extruder, it is preferred that the fluorinated polymer and the non-fluorinated polymer are fed into the extruder at the feeding zone at 10 to 30%, optionally 10 to 25%, and further optionally 15 to 25%, of the overall volume capacity at the feeding zone. It is also preferred that a screw speed of the extruder be set at 150 to 600 RPM. Alternatively, the screw speed of the extruder can be set at 300 to 600 RPM. Without being limited by any particular theory, it is believed that this feed rate for feeding the fluorinated and non-fluorinated polymers into the extruder facilitates production of a hybrid powder composition that achieves the stratification in monocoat layers 10 formed from the hybrid powder composition.

It is to be appreciated that the screw of the extruder for this extrusion method can include a single screw or multiple screws including two or more screws. Notably, the extruder and screw(s) are expressly and clearly disclosed in FIGS. 6A and 6B although these components are not specifically numbered in these Figures. Regardless of the number of screws, the kneading length Lₖ of the kneading zone is from greater than 50 to 60% of an effective length Lₛ of the screw (or screws), provided a total % for the feed length L_{f} and the kneading length Lₓ and the discharge length L_{d} is 100%.

With continued reference to FIG. 6A, although not required, in addition to the Lₖ/Lₛ being from greater than 50 to 60%, it is beneficial if the feed length L_{f} is 30 to 40% of the effective length Lₛ of the screw, and the discharge length L_{d} is 6 to 16% of the effective length Lₛ. In one preferred embodiment for the extrusion method, the feed length L_{f} is 32 to 38% of Lₛ, the kneading length Lₓ is 52 to 58% of Lₛ, and the discharge length Lₐ is 9 to 14% of Lₛ.

Now referring to FIG. 6B, during kneading, the fluorinated polymer and the non-fluorinated polymer may be kneaded at a temperature of 35 to 115, more typically 40 to 80, most typically 45 to 70, ° C. The preceding temperature ranges represent the temperature of the polymers. To achieve such a temperature for the fluorinated polymer and the non-fluorinated polymer during kneading, temperatures throughout the kneading zone of the extruder, commonly referred to as barrel temperatures, are typically set at 40 to 140, more typically at 48 to 120, ° C. The step of kneading includes melting the fluorinated polymer and the non-fluorinated polymer, and mixing the fluorinated polymer and the non-fluorinated polymer to form the hybrid powder composition. Furthermore, although not required, it is preferred that the kneading zone for this extrusion method is free of, i.e., does not have, a neutral zone. In other words, it is preferred that the screw or screws do not include a neutral kneading segment along the kneading length Lₖ. The fluorinated polymer and the non-fluorinated polymer are melted and mixed by the screw of the extruder. In the kneading step, the melting of the fluorinated polymer and the non-fluorinated polymer is typically conducted at a temperature of 51° C. or less, more typically at a temperature of 45 to 51° C. Then, in the kneading step, the mixing of the fluorinated polymer and the non-fluorinated polymer is typically conducted at a temperature above 51° C., more typically at a temperature from above 51 to 57° C.

As noted above, the fluorinated polymer and the non-fluorinated polymer that are used in this extrusion method can be functionalized, but they do not necessarily have to be. A particular fluorinated polymer for use in this extrusion method is the functionalized fluorinated polymer (A) described above, i.e., the functionalized fluorinated polymer including hydroxy and/or carboxylic acid functional groups and having the complex viscosity of 10 to 100 Pa-sec at 200° C. as measured in accordance with ASTM D4440-15, such as the FEVE polymer comprising hydroxy functional groups. A particular non-fluorinated polymer for use in this extrusion method is the non-fluorinated polymer (B) described above, i.e., the non-fluorinated polymer having a complex viscosity of 0.1 to 35 Pa-sec at 200° C. as measured in accordance with ASTM D4440-15. More particularly, it is beneficial if the non-fluorinated polymer used in this extrusion method is the functionalized thermoset polymer (B₁) comprising functional groups selected from hydroxy functional groups, carboxylic acid functional groups, epoxy functional groups, and combinations thereof, such as the polyester comprising hydroxy functional groups. The hybrid powder composition produced by this extrusion method may also further include the curing agent described above. If the curing agent is included, then at least one of the fluorinated polymer and the non-fluorinated polymer is functionalized for reaction with the curing agent.

Although not required, it is also beneficial for this extrusion method and the hybrid powder composition produced therefrom if the difference between the complex viscosity of the functionalized fluorinated polymer (A) and the complex viscosity of the non-fluorinated polymer (B) is at least 20, more typically at least 25, Pa-sec at 200° C. Alternatively, this difference between the complex viscosities of the functionalized fluorinated polymer (A) and the non-fluorinated polymer (B) used in the subject extrusion method is from 20 to 80, more typically from 20 to 60, Pa-sec at 200° C.

### EXAMPLES

The following examples, further illustrating the hybrid powder composition and cured monocoat layer 10 of this disclosure, are intended for descriptive, not limiting purposes. Those skilled in the art will recognize that equivalents of the following components and suppliers exist. As such, the components for the hybrid powder composition below are not to be construed as limiting.

In Example 1, where a weight ratio of the functionalized fluorinated polymer (A) and the non-fluorinated polymer (B) is 50/50, the components in Table 1 below are individually weighed and added into a sample bag of sufficient size/volume.

TABLE 1

| | Mass |
|---|---|
| Component | (grams) |
| Functionalized Fluorinated Polymer | 33.50 |
| (A) | |
| Non-Fluorinated Polymer (B) | 33.50 |
| Curing Agent | 7.50 |
| Additive - Flow Additive #1 | 0.90 |
| Additive - Flow Additive #2 | 0.90 |
| Additive - Degassing Agent | 0.50 |
| Additive - Extender Pigment #1 | 8.00 |
| Titanium Dioxide | 10.00 |
| Additive - Extender Pigment #2 | 3.70 |
| Additive - UV Absorber | 0.50 |
| Additive - HALS | 1.00 |
| Total: | 100.00 |

Functionalized Fluorinated Polymer (A) is Lumiflon® LF710F commercially available from AGC Chemicals Americas, Inc. of Exton, PA.

Non-Fluorinated Polymer (B) is SP-500 commercially available from Sun Polymers International, Inc. of Mooresville, IN;

Curing Agent is VESTAGON® B 1530 commercially available from Evonik Industries AG of Essen, Germany.

Flow Additive #1 is Resinflow PL-200 commercially available from Estron Chemical, Inc. of Calvert City, KY.

Flow Additive #2 is Resinflow PL-67 commercially available from Estron Chemical, Inc. of Calvert City, KY.

Degassing Agent is benzoin commercially available from Estron Chemical, Inc. of Calvert City, KY.

Extender Pigment #1 is MINEX® 10 commercially available from Sibelco Specialty Minerals of Antwerp, Belgium.

Titanium Dioxide is Ti-Pure™ TS-6200 commercially available from Ti-Pure™, The Chemours Company of Wilmington, Delaware.

Extender Pigment #2 is FP-480 Opacity Pigment™ commercially available from FP-Pigments Oy of Espoo, Finland.

UV Absorber is Tinuvin® PA 144 commercially available from BASF Corporation of Florham Park, NJ.

HALS is Tinuvin® 460 commercially available from BASF Corporation of Florham Park, NJ.

After the components in Table 1 are weighed and added into the sample bag, the contents of the sample bag, in the form of a powder, are then added to a laboratory grinder for pre-mixing. The contents are pre-mixed in the grinder for approximately 4 seconds to mill the powder into a pre-mix composition having a finer particle size.

The pre-mix composition is then collected into the sample bag for processing with and through an extruder having a feeding zone, a kneading zone, and a discharging zone. For Example 1, the extruder is an MP24PC Integra Extruder with Integrated Chill Roll commercially available from Baker Perkins. The extruder is warmed-up, and the screws of the extruder are set to rotate at 300 RPM. The pre-mix composition is dumped from the sample bag into a feed box, or feed hopper, of the extruder. From there, the pre-mix composition is conveyed and fed into an opening of the extruder. More specifically, the screws of the feed box are set at 20% of an overall volume capacity at the feeding zone for feeding the pre-mix into the extruder, and the pre-mix composition, including the fluorinated polymer (Lumiflon® LF710F) and the non-fluorinated polymer (SP-500), is fed via the screws into the feeding zone of the extruder. For Example 1, the feed length L_{f} of the feeding zone is 34.62% of the effective length Lₛ of the screws.

In the extruder, the contents, including the fluorinated polymer and the non-fluorinated polymer, are kneaded, more specifically melted and mixed, in the kneading zone to form the hybrid powder composition. For Example 1, the kneading length Lₓ of the kneading zone is 53.85% of the effective length Lₛ of the screws, and the temperature at kneading is 35to 115, more specifically 48 to 104, and most specifically 85 to 100, ° C. The hybrid powder composition of Example 1 is then discharged from the discharging zone of the extruder. For Example 1, the discharge length Lₐ of the discharging zone is 11.53% of the effective length Lₛ of the screws. Notably, as exemplified in Example 1, the total % for the feed length L_{f} and the kneading length Lₓ and the discharge length Lₐ is 100%. The hybrid powder composition of Example 1 is then poured into the chill roll of the extruder, compressed into flakes, and collected into a discharge pan. The hybrid powder composition of Example 1, now in the physical form of flakes with the contents of Example 1 compounded in the flakes, is collected into a finished bag.

From the finished bag, the compounded flakes of Example 1 are then sieved using a Retsch AS 200 Vibratory Sieve for subsequent application by spraying and then curing to form the cured monocoat layer 10. For the spraying, the hybrid powder composition of Example 1 is manually, or hand, sprayed onto the substrate to form the monocoat layer using the Encore® LT Manual Powder Coating System commercially available from Nordson Corporation of Westlake, OH (the Encore® System). For Example 1, the controller of the Encore® System is configured as follows: (i) Smart Flow mode; (ii) Classic/Standard Electrostatic mode at 60 kV; (iii) Setting at ‘9’ for Powder Flow Rate/Flow Air %; and (iv) Setting at ‘50’ for Total Flow. With these configurations, the operator sprays back-and-forth across the substrate, totaling one pass, achieving the film build for the monocoat layer in the one pass for subsequent curing. For the curing, the substrate including the sprayed monocoat layer is cured in an oven in a vertical orientation at 200° C. for 20 minutes to form the cured monocoat layer 10.

Refer now to Table 2 below for Examples 2A-2W, which are inclusive of both comparative and inventive examples. Specifically, Examples 2A-2H and 2T-2W are comparative examples and Examples 21-2S are inventive examples. All of Examples 2A-2W, whether comparative or inventive, are loaded in accordance with the description above for Example 1. To this end, Example 2L in Table 2 below is equivalent to Example 1 in Table 1 above.

For the hybrid powder coating compositions of Examples 2A-2W, all of the individual components are the same as those described above with regard to Example 1. The only variable for the hybrid powder coating compositions is the changing weight ratio for the functionalized fluorinated polymer (A) and the non-fluorinated polymer (B) (Column [3]). Finally, Examples 2A-2W were extruded, sprayed, and cured as described above with regard to Example 1.

TABLE 2

| | | | | Column | Column |
|---|---|---|---|---|---|
| | | | Column | [5] | [6] |
| | | | [4] | Overall | Column |
| | | Column | Thickness of | Thickness | [4]/ |
| Column | Column | [3] | F-Dominant | of Cured | Column |
| [1] | [2] | Weight | Top Film | Monocoat | [5] |
| Example | Type of | Ratio | Phase | Layer | Percent |
| No. | Example | (A/B) | (microns) | (microns) | (%) |
| 2A | Comparative | 80/20 | 0 | 38.8 | 0 |
| 2B | Comparative | 77/23 | 0 | 33.8 | 0 |
| 2C | Comparative | 75/25 | 0 | 43.8 | 0 |
| 2D | Comparative | 73/27 | 0 | 45.9 | 0 |
| 2E | Comparative | 70/30 | 0 | 44.6 | 0 |
| 2F | Comparative | 68/32 | 0 | 56.3 | 0 |
| 2G | Comparative | 65/35 | 0 | 52.8 | 0 |
| 2H | Comparative | 63/37 | 0 | 54.7 | 0 |
| 2I | Inventive | 60/40 | 23.8 | 45.7 | 52 |
| 2J | Inventive | 55/45 | 21.9 | 51.5 | 43 |
| 2K | Inventive | 52/48 | 24.8 | 53.9 | 46 |
| 2L | Inventive | 50/50 | 26.7 | 57.8 | 46 |
| 2M | Inventive | 48/52 | 17.2 | 40.9 | 42 |
| 2N | Inventive | 45/55 | 17.4 | 42.3 | 41 |
| 2O | Inventive | 40/60 | 24 | 56.8 | 42 |
| 2P | Inventive | 37/63 | 25.4 | 67.3 | 38 |
| 2Q | Inventive | 35/65 | 19.5 | 66.5 | 29 |
| 2R | Inventive | 33/67 | 14.3 | 48.6 | 29 |
| 2S | Inventive | 30/70 | 9.5 | 36.7 | 26 |
| 2T | Comparative | 27/73 | 0 | 55.7 | 0 |
| 2U | Comparative | 25/75 | 0 | 43.0 | 0 |
| 2V | Comparative | 23/77 | 0 | 42.5 | 0 |
| 2W | Comparative | 20/80 | 0 | 40.9 | 0 |

The data presented in Table 2 above establishes that the inventive weight ratio for the functionalized fluorinated polymer (A) and the non-fluorinated polymer (B) of 60/40 to 30/70, including the more specific weight ratios between 60/40 to 30/70 (see Examples 21-2S), drives the stratification in the cured monocoat layer 10. In Examples 2I-2S, there exists stratification with a top film phase 16 of fluorine dominance having a thickness ranging from 9.5 to 26.7 microns. Furthermore, referring to Column [6] in Table 2, Examples 2I-2S result in a thickness of the top film phase 16 ranging from 26 to 52% of the overall cured film thickness of the cured monocoat layer 10. This particular weight ratio of the functionalized fluorinated polymer (A) and the non-fluorinated polymer (B) of 60/40 to 30/70 renders the hybrid powder composition ‘self-stratifying’ thereby driving the stratification in the cured monocoat layer 10.

In contrast, with weight ratios of the functionalized fluorinated polymer (A) and the non-fluorinated polymer (B) outside the range of 60/40 to 30/70 (see Examples 2A-2H and 2T-2W), the hybrid powder composition is not ‘self-stratifying’. As a result, cured monocoat layers formed from such hybrid powder compositions are not stratified, i.e., there is no top film phase at all, as exemplified by the thickness of 0 microns in Column [4] and by the 0% in Column [6] of Table 2 for Examples 2A-2H and 2T-2W.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

What is claimed is:

1. A hybrid powder composition for forming a stratified monocoat layer, said composition comprising:
(A) a functionalized fluorinated polymer comprising hydroxy and/or carboxylic acid functional groups and having a complex viscosity of 10 to 100 Pa-sec at 200° C. as measured in accordance with ASTM D4440-15; and
(B) a non-fluorinated polymer having a complex viscosity of 0.1 to 35 Pa-sec at 200° C. as measured in accordance with ASTM D4440-15, wherein a weight ratio of said functionalized fluorinated polymer (A) and said non-fluorinated polymer (B) is from 60/40 to 30/70.

2. The hybrid powder composition as set forth in claim 1 wherein a difference between said complex viscosity of said functionalized fluorinated polymer (A) and said complex viscosity of said non-fluorinated polymer (B) is at least 20 Pa-sec at 200° C.

3. The hybrid powder composition as set forth in claim 1 wherein said functionalized fluorinated polymer (A) has an OH value of 10 to 100 mg KOH/g polymer, and said non-fluorinated polymer (B) has an OH value of 5 to 200 mg KOH/g polymer.

4. The hybrid powder composition as set forth in claim 3 wherein said functionalized fluorinated polymer (A) has a glass transition temperature, T_{g}, of 10 to 90° C., and said non-fluorinated polymer (B) has a glass transition temperature, T_{g}, of 30 to 90° C.

5. The hybrid powder composition as set forth in claim 4 wherein said functionalized fluorinated polymer (A) has a complex viscosity of 25 to 70 Pa-sec at 200° C. and an OH value of 30 to 80 mg KOH/g polymer, and said non-fluorinated polymer (B) has a complex viscosity of 0.3 to 20 Pa-sec at 200° C. and an OH value of 10 to 180 mg KOH/g polymer.

6. The hybrid powder composition as set forth in claim 1 wherein said functionalized fluorinated polymer (A) is selected from copolymers of tetrafluoroethylene, polymers of tetrafluorethylene, copolymers of fluoroethylene vinyl ether (FEVE), polymers of FEVE, copolymers of fluoroethylene vinyl ester, polymers of fluoroethylene vinyl ester, and combinations thereof.

7. The hybrid powder composition as set forth in claim 1 wherein said functionalized fluorinated polymer (A) comprises a FEVE polymer comprising hydroxy functional groups.

8. The hybrid powder composition as set forth in claim 7 wherein said FEVE polymer has a complex viscosity of 35 to 50 Pa-sec at 200° C. and an OH value of 40 to 50 mg KOH/g polymer.

9. The hybrid powder composition as set forth in claim 1 wherein said functionalized fluorinated polymer (A) comprises a FEVE polymer comprising carboxylic acid functional groups.

10. The hybrid powder composition as set forth in claim 1 wherein said non-fluorinated polymer (B) comprises a functionalized thermoset polymer (B1) comprising functional groups selected from hydroxy functional groups, carboxylic acid functional groups, epoxy functional groups, and combinations thereof.

11. The hybrid powder composition as set forth in claim 10 wherein said functionalized thermoset polymer (B1) is selected from polyesters, polyurethanes, acrylics, epoxies, and combinations thereof.

12. The hybrid powder composition as set forth in claim 10 wherein said functionalized thermoset polymer (B1) comprises a polyester comprising hydroxy functional groups.

13. The hybrid powder composition as set forth in claim 12 wherein said polyester has a complex viscosity of 0.5 to 10 Pa-sec at 200° C. and an OH value of 20 to 140 mg KOH/g polymer.

14. The hybrid powder composition as set forth in claim 7 wherein said functionalized thermoset polymer (B1) comprises a polyester comprising hydroxy functional groups.

15. The hybrid powder composition as set forth in claim 1 wherein said weight ratio of said functionalized fluorinated polymer (A) and said non-fluorinated polymer (B) is from 60/40 to 40/60.

16. The hybrid powder composition as set forth in claim 1 further comprising titanium dioxide (TiO₂₎.

17. The hybrid powder composition as set forth in of claim 1 further comprising a curing agent reactive with at least one of said functionalized fluorinated polymer (A) and said non-fluorinated polymer (B), wherein said curing agent is selected from a blocked isocyanate, triglycidyl isocyanurate, hydroxyalkyl amide, and combinations thereof.

18. A cured monocoat layer disposed on a substrate and formed from a hybrid powder composition, wherein said cured monocoat layer has an overall cured film thickness of 25 to 100 microns and is stratified between a top film phase, a bottom film phase opposite said top film phase to be adjacent the substrate, and an intermediate film phase between said top and bottom film phases, and wherein said top film phase is fluorine-dominant relative to both said bottom film phase and said intermediate film phase.

19. The cured monocoat layer as set forth in claim 18 wherein said top film phase has a film thickness of at least 8 microns.

20. The cured monocoat layer as set forth in claim 18 wherein a thickness of said top film phase is 25 to 55% of said overall cured film thickness of said cured monocoat layer.

21. An extrusion method for producing a hybrid powder composition comprising a fluorinated polymer and a non-fluorinated polymer, said method comprising:
feeding the fluorinated polymer and the non-fluorinated polymer into an extruder with a screw at a feeding zone having a feed length L_{f};
kneading the fluorinated polymer and the non-fluorinated polymer in a kneading zone of the extruder having a kneading length Lₖ to form the hybrid powder composition; and
discharging the hybrid powder composition from a discharging zone of the extruder having a discharge length L_{d},
wherein the kneading length Lₖ is from greater than 50 to 60% of an effective length Lₛ of the screw, provided a total % for the feed length L_{f} and the kneading length Lₖ and the discharge length Lₐ is 100%.

22. The extrusion method as set forth in claim 21 wherein the feed length L_{f} is 30 to 40% of the effective length Lₛ of the screw, and the discharge length Lₐ is 6 to 16% of the effective length Lₛ.

23. The extrusion method as set forth in claim 21 wherein a weight ratio of the fluorinated polymer and the non-fluorinated polymer that is fed into the extruder is from 60/40 to 30/70.
